(19) United States
(12) Patent Application Publication
(10) Pub. No.: US 2022/0352824 A1
(43) Pub. Date: Nov. 3, 2022

(54) LLC CONVERTER CIRCUIT

(71) Applicant: Power Forest Technology Corporation, Hsinchu County (TW)

(72) Inventors: Chao-Chang Chiu, Hsinchu County (TW); Chien-Wei Kuan, Hsinchu County (TW)

(73) Assignee: Power Forest Technology Corporation, Hsinchu County (TW)

(21) Appl. No.: 17/406,057

(22) Filed: Aug. 18, 2021

(30) Foreign Application Priority Data
Apr. 28, 2021 (TW) 110115301

(51) Int. Cl. H02M 3/337; H02M 1/00; H02M 3/335

(52) U.S. Cl. CPC H02M 3/3376; H02M 1/0022; H02M 3/33507

(57) ABSTRACT

An LLC converter circuit is provided. A control circuit provides a first control signal and a second control signal according to a sensing voltage generated by sensing a voltage on a resonant capacitor of a primary side, so as to control a conduction state of a half-bridge switch circuit.

### CROSS-REFERENCE TO RELATED APPLICATION

This application claims the priority benefit of Taiwan application serial no. 110115301, filed on Apr. 28, 2021. The entirety of the above-mentioned patent application is hereby incorporated by reference herein and made a part of this specification.

### BACKGROUND

### Technical Field

The disclosure relates to a converter, and particularly relates to an LLC converter circuit.

### Related Art

An LLC converter is a DC/DC converter that includes an LLC resonant circuit composed of a leakage inductance and a magnetizing inductance of a transformer and a capacitor, a signal generation circuit (such as a half-bridge circuit) generating a square wave shaped voltage signal supplied to the LLC resonant circuit, and a rectifier circuit rectifying an output of the transformer.

In the LLC converter, in order to reduce variation in an output voltage during a load change, the output voltage or the like is used for feedback control of a switching frequency. However, in a general LLC converter, since the feedback control is performed by sending a signal output from a secondary side of the transformer back to a primary side of the transformer via an optocoupler, problems such as slow response speed and insufficient bandwidth may occur.

### SUMMARY

The disclosure provides an LLC converter circuit, in which problems of a conventional LLC converter circuit, such as slow response speed and insufficient bandwidth, can be reduced.

An LLC converter circuit of the disclosure includes a half-bridge switch circuit, a transformer, a resonant network, a sensing circuit, a control circuit, and a ramp voltage generation circuit. The half-bridge switch circuit has a first input terminal receiving an input voltage and a second input terminal. The half-bridge switch circuit is controlled by a first control signal and a second control signal to alternately connect an output terminal of the half-bridge switch circuit to the first input terminal and the second input terminal. The transformer includes a primary coil and a secondary coil. A first terminal of the primary coil is coupled to the output terminal of the half-bridge switch circuit. The secondary coil is coupled to an output terminal of the LLC converter circuit. The resonant network is coupled to the output terminal of the half-bridge switch circuit. The resonant network includes a resonant capacitor coupled between a second terminal of the primary coil and ground. The sensing circuit is coupled to the second terminal of the primary coil, and senses a voltage on the resonant capacitor to generate a sensing voltage. The control circuit is coupled to the sensing circuit and the half-bridge switch circuit, and generates the first control signal and the second control signal. The control circuit includes an amplifier circuit. The amplifier circuit generates a first threshold voltage and a second threshold voltage respectively at a first output terminal and a second output terminal of the amplifier circuit according to a first common-mode voltage and a feedback signal generated in response to an output voltage of the LLC converter circuit. The control circuit generates the first control signal and the second control signal according to the sensing voltage, the first threshold voltage and the second threshold voltage. The ramp voltage generation circuit is coupled to the control circuit. The ramp voltage generation circuit generates a ramp voltage according to the first control signal and the second control signal, so as to adjust the first common-mode voltage or adjust the first threshold voltage and the second threshold voltage.

In an embodiment of the disclosure, the control circuit further includes a first comparator, a second comparator, and a logic control circuit. The first comparator has a positive input terminal and a negative input terminal respectively coupled to the first threshold voltage and the sensing voltage. The second comparator has a positive input terminal and a negative input terminal respectively coupled to the second threshold voltage and the sensing voltage. The logic control circuit is coupled to an output terminal of the first comparator and an output terminal of the second comparator. The logic control circuit generates the first control signal and the second control signal according to a comparison result of the first comparator and a comparison result of the second comparator.

In an embodiment of the disclosure, the control circuit further includes a first adder circuit and a second adder circuit. The first adder circuit is coupled to the ramp voltage generation circuit, the first output terminal of the amplifier circuit, and the positive input terminal of the first comparator. The first adder circuit adds the ramp voltage and the first threshold voltage, so as to adjust the first threshold voltage to generate a third threshold voltage. The second adder circuit is coupled to the ramp voltage generation circuit, the second output terminal of the amplifier circuit, and the positive input terminal of the second comparator. The second adder circuit adds the ramp voltage and the second threshold voltage, so as to adjust the second threshold voltage to generate a fourth threshold voltage.

In an embodiment of the disclosure, the control circuit further includes an adder circuit coupled to the ramp voltage generation circuit, the first common-mode voltage and an input terminal of the amplifier circuit. The adder circuit adds the ramp voltage and the first common-mode voltage, so as to adjust the first common-mode voltage to generate a second common-mode voltage.

In an embodiment of the disclosure, the LLC converter circuit further includes a unity gain amplifier circuit having a positive input terminal coupled to the first common-mode voltage and having a negative input terminal and an output terminal coupled to each other. The output terminal of the unity gain amplifier circuit is coupled to the negative input terminal of the first comparator and the negative input terminal of the second comparator.

In an embodiment of the disclosure, the LLC converter circuit further includes a feedback circuit coupled to the output terminal of the LLC converter circuit and an input terminal of the amplifier circuit. The feedback circuit generates the feedback signal according to the output voltage of the LLC converter circuit.

In an embodiment of the disclosure, the LLC converter circuit includes a first output terminal and a second output terminal. The feedback signal includes a first feedback signal and a second feedback signal generated in response to a first output voltage on the first output terminal and a second output voltage on the second output terminal.

In an embodiment of the disclosure, the ramp voltage generation circuit includes a first current source, a first switch, a second switch, a second current source, and a capacitor. The first current source is coupled to a reference voltage. The first switch is coupled between the first current source and an output terminal of the ramp voltage generation circuit. The second switch has one terminal coupled to the output terminal of the ramp voltage generation circuit. The second current source is coupled between the other terminal of the second switch and the ground. The capacitor is coupled between the output terminal of the ramp voltage generation circuit and the ground. The first switch and the second switch are controlled by the first control signal and the second control signal to change conduction state, thereby generating the ramp voltage at the output terminal of the ramp voltage generation circuit.

In an embodiment of the disclosure, the sensing circuit is a voltage divider circuit or a high-pass filter circuit.

In an embodiment of the disclosure, the sensing circuit includes a capacitor and a resistor. The resistor is coupled to the capacitor between the second terminal of the primary coil and the ground. The sensing voltage is generated on a common contact of the capacitor and the resistor.

In an embodiment of the disclosure, the sensing circuit includes a first capacitor and a second capacitor. The second capacitor is coupled to the first capacitor between the second terminal of the primary coil and the ground. The sensing voltage is generated on a common contact of the first capacitor and the second capacitor.

Based on the above, in the embodiments of the disclosure, the control circuit provides the first control signal and the second control signal according to the sensing voltage generated by sensing the voltage on the resonant capacitor of the primary side, so as to control the conduction state of the half-bridge switch circuit. In this way, by controlling on/off switching of the half-bridge switch circuit according to the sensing voltage from the primary side, response speed and bandwidth of the LLC converter circuit can be effectively improved.

### BRIEF DESCRIPTION OF THE DRAWINGS

FIG. 1 is a schematic diagram of an LLC converter circuit according to an embodiment of the disclosure.

FIG. 2 is a schematic diagram of a ramp voltage generation circuit and a control circuit according to an embodiment of the disclosure.

FIG. 3 and FIG. 4 are schematic diagrams of a sensing circuit according to an embodiment of the disclosure.

FIG. 5 is a schematic diagram of waveforms of threshold voltage, common-mode voltage, sensing voltage, control signal, and ramp voltage according to an embodiment of the disclosure.

FIG. 6 is a schematic diagram of a control circuit and a ramp voltage generation circuit according to another embodiment of the disclosure.

FIG. 7 is a schematic diagram of waveforms of threshold voltage, common-mode voltage, sensing voltage, control signal, and ramp voltage according to another embodiment of the disclosure.

FIG. 8 is a schematic diagram of an LLC converter circuit according to another embodiment of the disclosure.

FIG. 9 is a schematic diagram of a ramp voltage generation circuit and a control circuit according to another embodiment of the disclosure.

FIG. 10 is a schematic diagram of waveforms of threshold voltage, common-mode voltage, sensing voltage, control signal, and ramp voltage according to another embodiment of the disclosure.

FIG. 11 is a schematic diagram of a control circuit and a ramp voltage generation circuit according to another embodiment of the disclosure.

FIG. 12 is a schematic diagram of waveforms of threshold voltage, common-mode voltage, sensing voltage, control signal, and ramp voltage according to another embodiment of the disclosure.

### DESCRIPTION OF THE EMBODIMENTS

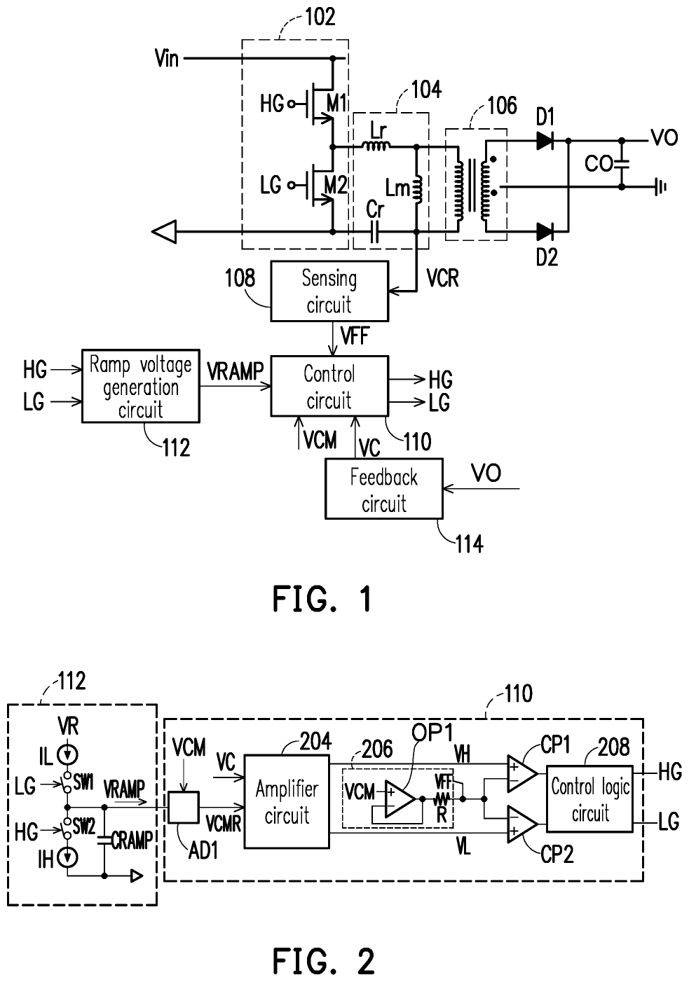

FIG. 1 is a schematic diagram of an LLC converter circuit according to an embodiment of the disclosure. Please refer to FIG. 1. The LLC converter circuit may include a half-bridge switch circuit 102, a resonant network 104, a transformer 106, a sensing circuit 108, a control circuit 110, a ramp voltage generation circuit 112, and a feedback circuit 114. The resonant network 104 is coupled to the half-bridge switch circuit 102, the transformer 106, and the sensing circuit 108. The transformer 106 may be coupled to an output terminal of the half-bridge switch circuit 102 via a rectifier diode D1, a rectifier diode D2 and an output capacitor CO. The control circuit 110 is coupled to the sensing circuit 108 and the ramp voltage generation circuit 112. The feedback circuit 114 is coupled between an output terminal of the LLC converter circuit and the control circuit 110.

Specifically, the half-bridge switch circuit 102 has a first input terminal and a second input terminal. In the present embodiment, the first input terminal of the half-bridge switch circuit 102 is coupled to an input voltage Vin, and the second input terminal of the half-bridge switch circuit 102 is coupled to ground. The half-bridge switch circuit 102 may be controlled by a control signal HG and a control signal LG to alternately connect the output terminal of the half-bridge switch circuit 102 to the first input terminal and the second input terminal, such that the half-bridge switch circuit 102 alternately outputs the input voltage Vin and a ground voltage. The input voltage Vin is a DC voltage. In the present embodiment, the half-bridge switch circuit 102 may be implemented by a transistor M1 and a transistor M2 connected in series between the first input terminal and the second input terminal. The transistor M1 and the transistor M2 are respectively coupled to the control signal HG and the control signal LG.

An output voltage of the half-bridge switch circuit 102 may be input to a primary coil of the transformer 106 via the resonant network 104, such that the transformer 106 performs voltage conversion according to a preset ratio. Then, an AC voltage output by the transformer 106 is converted into a DC voltage by the rectifier diodes D1 and D2 and the output capacitor CO, and an output voltage VO is generated on the output capacitor CO. The rectifier diode D1 is coupled between a first terminal of a secondary coil of the transformer 106 and the output terminal of the half-bridge switch circuit 102. The rectifier diode D2 is coupled between a second terminal of the secondary coil of the transformer 106 and the output terminal of the half-bridge switch circuit 102. The output capacitor CO is coupled between the output terminal of the half-bridge switch circuit 102 and a center tap contact. In the present embodiment, the resonant network 104 is an LLC resonant network and may include a resonant capacitor Cr, a resonant inductance Lr, and a magnetizing inductance Lm. The resonant inductance Lr is coupled to the output terminal of the half-bridge switch circuit 102 and a first terminal of the primary coil. The magnetizing inductance Lm is coupled between the first terminal and a second terminal of the primary coil. The resonant capacitor Cr is coupled between the second terminal of the primary coil and the ground. The resonant inductance Lr may be a leakage inductance of the transformer 106, or an inductance of an inductor provided independently of the transformer 106, or an inductance obtained by combining the leakage inductance of the transformer 106 with the inductance of the inductor.

The sensing circuit 108 may sense a voltage VCR on the resonant capacitor Cr and generate a sensing voltage VFF. According to a common-mode voltage VCM, a feedback signal VC generated by the feedback circuit 114 in response to the output voltage VO, a ramp voltage VRAMP generated by the ramp voltage generation circuit 112, and the sensing voltage VFF, the control circuit 110 may generate the control signals HG and LG. Specifically, the control circuit 110 may include an amplifier circuit. The amplifier circuit may generate two threshold voltages according to the common-mode voltage VCM and the feedback signal VC. According to these two threshold voltages and the sensing voltage VFF, the control circuit 110 may generate the control signals HG and LG. The control signals HG and LG may not only control a conduction state of the half-bridge switch circuit 102, but may also control the ramp voltage VRAMP generated by the ramp voltage generation circuit 112. The ramp voltage VRAMP generated by the ramp voltage generation circuit 112 may be used to adjust the common-mode voltage VCM or the aforesaid two threshold voltages. In this way, by controlling on/off switching of the half-bridge switch circuit 102 according to the sensing voltage VFF from the primary side of the transformer 106, response speed and bandwidth of the LLC converter circuit can be effectively improved.

In detail, as shown in FIG. 2, the ramp voltage generation circuit 112 may include a current source IH, a current source IL, a switch SW1, a switch SW2, and a capacitor CRAMP. The current source IL and the switch SW1 are coupled between a reference voltage VR and an output terminal of the ramp voltage generation circuit 112. The switch SW2 and the current source IH are coupled between the output terminal of the ramp voltage generation circuit 112 and the ground. The capacitor CRAMP is coupled between the output terminal of the ramp voltage generation circuit 112 and the ground.

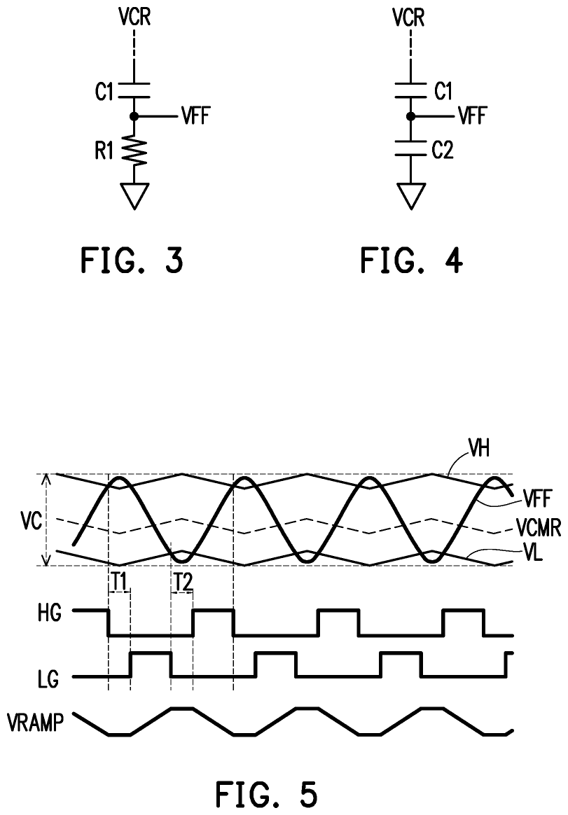

In addition, the control circuit 110 may include an adder circuit AD1, an amplifier circuit 204, a unity gain amplifier circuit 206, a comparator CP1, a comparator CP2, and a control logic circuit 208. The adder circuit AD1 is coupled between the output terminal of the ramp voltage generation circuit 112 and one input terminal of the amplifier circuit 204. Another input terminal of the amplifier circuit 204 receives the feedback signal VC generated by the feedback circuit 114 in response to the output voltage VO. A first output terminal and a second output terminal of the amplifier circuit 204 are respectively coupled to a positive input terminal of the comparator CP1 and a positive input terminal of the comparator CP2. Negative input terminals of the comparators CP1 and CP2 are coupled to the sensing circuit 108 to receive the sensing voltage VFF. The sensing circuit 108 may be, for example, a voltage divider circuit or a high-pass filter circuit. For example, as shown in FIG. 3, the sensing circuit 108 may include a capacitor C1 and a resistor R1 connected in series between the resonant capacitor Cr and the ground, and the sensing voltage VFF may be generated on a common contact of the capacitor C1 and the resistor R1. Alternatively, as shown in FIG. 4, the sensing circuit 108 may include a capacitor C1 and a capacitor C2 connected in series between the resonant capacitor Cr and the ground, and the sensing voltage VFF may be generated on a common contact of the capacitor C1 and the capacitor C2.

An input terminal of the unity gain amplifier circuit 206 is coupled to the common-mode voltage VCM, and an output terminal of the unity gain amplifier circuit 206 is coupled to the negative input terminals of the comparators CP1 and CP2, so that the common-mode voltage VCM is applied to the negative input terminals of the comparators CP1 and CP2, thereby adjusting a voltage level of the sensing voltage VFF. In the present embodiment, the unity gain amplifier circuit 206 may be implemented by, for example, an operational amplifier OP1 and a resistor R. In the operational amplifier OP1, a negative input terminal and an output terminal are coupled to each other. A positive input terminal of the operational amplifier OP1 is coupled to the common-mode voltage VCM. The resistor R is coupled between the output terminal of the operational amplifier OP1 and the negative input terminals of the comparators CP1 and CP2. Output terminals of the comparators CP1 and CP2 are coupled to the control logic circuit 208.

The switch SW1 and the switch SW2 may be respectively controlled by the control signal LG and the control signal HG to be turned on alternately to charge and discharge the capacitor CRAMP, thereby generating the ramp voltage VRAMP on the capacitor CRAMP. The adder circuit AD1 may add the ramp voltage VRAMP and the common-mode voltage VCM, so as to adjust a voltage level of the common-mode voltage VCM and generate a common-mode voltage VCMR. The amplifier circuit 204 may output a threshold voltage VH and a threshold voltage VL according to the common-mode voltage VCMR and the feedback signal VC. The comparator CP1 may compare the threshold voltage VH with the sensing voltage VFF after voltage level adjustment, and output a comparison result to the control logic circuit 208. Similarly, the comparator CP2 may compare the threshold voltage VL with the sensing voltage VFF after voltage level adjustment, and output a comparison result to the control logic circuit 208. According to the comparison results from the comparators CP1 and CP2, the control logic circuit 208 may generate the control signals HG and LG.

Specifically, the threshold voltages VH and VL, the common-mode voltage VCMR, the sensing voltage VFF, the control signals HG and LG, and the ramp voltage VRAMP of the present embodiment may be as shown in FIG. 5. A voltage difference between a peak of the threshold voltage VH and a valley of the threshold voltage VL is equal to a voltage difference between the feedback signal VC and the ground. The value of the common-mode voltage VCMR changes as the ramp voltage VRAMP changes. When the value of the sensing voltage VFF changes from being lower than the threshold voltage VH to being higher than the threshold voltage VH, the control logic circuit 208 converts the control signal HG to a low voltage level. After a period of time T1 has passed since the control signal HG is converted to the low voltage level, the control logic circuit 208 converts the control signal LG to a high voltage level. In addition, when the value of the sensing voltage VFF changes from being higher than the threshold voltage VL to being lower than the threshold voltage VL, the control logic circuit 208 converts the control signal LG from a high voltage level to a low voltage level. After a period of time T2 has passed since the control signal LG is converted to the low voltage level, the control logic circuit 208 converts the control signal HG to a high voltage level. A duty ratio between the control signals HG and LG may be adjusted by changing a slope of the ramp voltage VRAMP, that is, by changing a rising speed and a falling speed of the ramp voltage VRAMP. For example, the capacitor CRAMP may be a variable capacitor and may be controlled by the control circuit 110 to change its capacitance, thereby adjusting the rising speed and falling speed of the ramp voltage VRAMP.

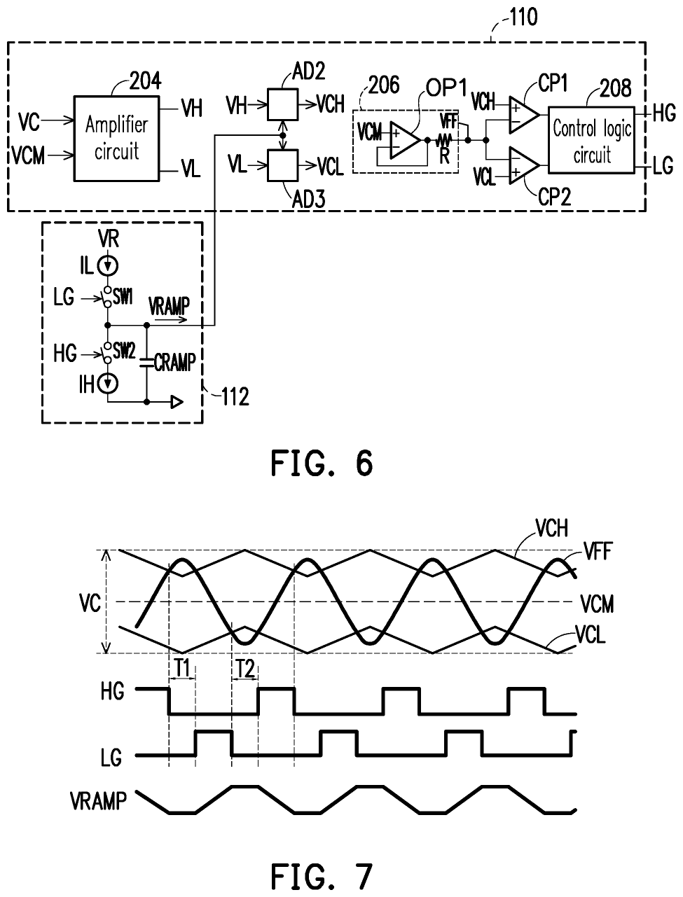

FIG. 6 is a schematic diagram of a control circuit and a ramp voltage generation circuit according to another embodiment of the disclosure. A difference between the present embodiment and the embodiment of FIG. 2 is that in the present embodiment, the control circuit 110 includes two adder circuits denoted by AD2 and AD3. Two input terminals of the adder circuit AD2 are coupled to the first output terminal of the amplifier circuit 204 and the output terminal of the ramp voltage generation circuit 112. An output terminal of the adder circuit AD2 is coupled to the positive input terminal of the comparator CP1. Two input terminals of the adder circuit AD3 are coupled to the second output terminal of the amplifier circuit 204 and the output terminal of the ramp voltage generation circuit 112. An output terminal of the adder circuit AD3 is coupled to the positive input terminal of the comparator CP2. That is, in the present embodiment, the ramp voltage generation circuit 112 is configured to adjust the threshold voltages VH and VL output by the amplifier circuit 204, that is, to add the ramp voltage VRAMP to the threshold voltage VH and the threshold voltage VL respectively to obtain an adjusted threshold voltage VCH and an adjusted threshold voltage VCL. The adder circuits AD2 and AD3 output the adjusted threshold voltages VCH and VCL to the positive input terminals of the comparators CP1 and CP2, such that the comparators CP1 and CP2 generate comparison results according to the adjusted threshold voltages VCH and VCL, and the sensing voltage VFF after voltage level adjustment. Further, according to the comparison results from the comparators CP1 and CP2, the control logic circuit 208 generates the control signals HG and LG.

As shown in FIG. 7, in the present embodiment, instead of being configured to adjust the common-mode voltage VCM, the ramp voltage generation circuit 112 is configured to adjust the threshold voltages VH and VL. Accordingly, the common-mode voltage VCM remains at a constant value, and a voltage difference between a peak of the adjusted threshold voltage VCH and a valley of the adjusted threshold voltage VCL is equal to the voltage difference between the feedback signal VC and the ground. Similarly, in the present embodiment, when the value of the sensing voltage VFF changes from being lower than the adjusted threshold voltage VCH to being higher than the adjusted threshold voltage VCH, the control logic circuit 208 converts the control signal HG to a low voltage level. After the period of time T1 has passed since the control signal HG is converted to the low voltage level, the control logic circuit 208 converts the control signal LG to a high voltage level. In addition, when the value of the sensing voltage VFF changes from being higher than the adjusted threshold voltage VCL to being lower than the adjusted threshold voltage VCL, the control logic circuit 208 converts the control signal LG from a high voltage level to a low voltage level. After the period of time T2 has passed since the control signal LG is converted to the low voltage level, the control logic circuit 208 converts the control signal HG to a high voltage level.

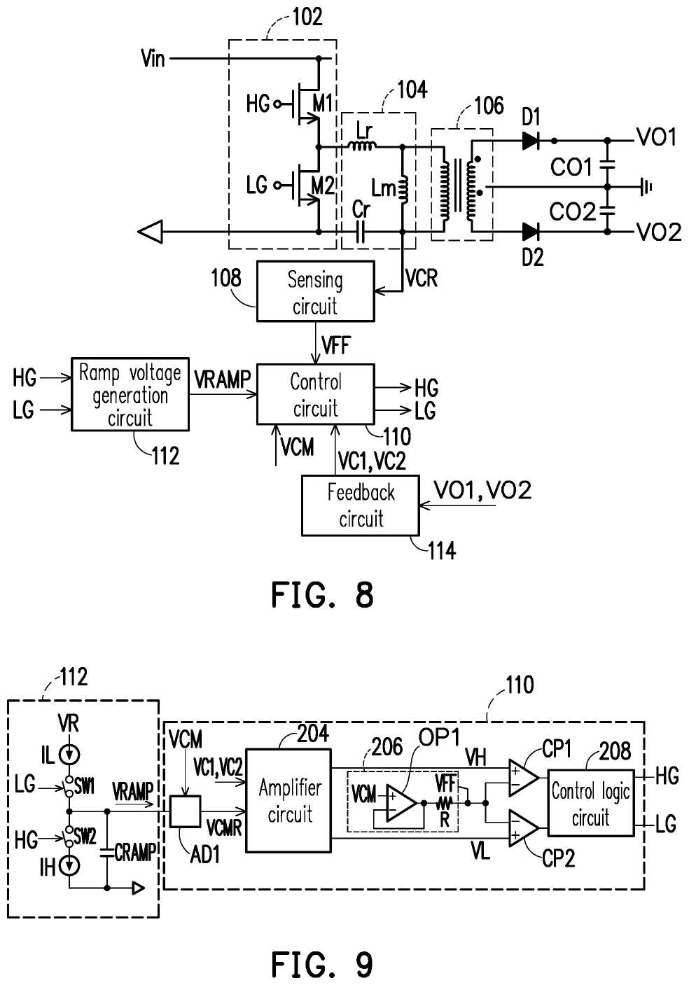

It is worth noting that the above embodiment has described an example where the LLC converter circuit has one output terminal. However, the disclosure is not limited thereto. For example, FIG. 8 is a schematic diagram of an LLC converter circuit according to another embodiment of the disclosure. Compared with the embodiment of FIG. 1, an output stage of the LLC converter circuit of the present embodiment includes the rectifier diode D1, the rectifier diode D2, an output capacitor CO1 and an output capacitor CO2. The rectifier diode D1 is coupled between the first terminal of the secondary coil of the transformer 106 and a first output terminal of the half-bridge switch circuit 102. The rectifier diode D2 is coupled between the second terminal of the secondary coil of the transformer 106 and a second output terminal of the half-bridge switch circuit 102. The output capacitor CO1 is coupled between the first output terminal of the half-bridge switch circuit 102 and a center tap contact. The output capacitor CO2 is coupled between the second output terminal of the half-bridge switch circuit 102 and the center tap contact. An AC voltage output by the transformer 106 may be converted into a DC voltage by the rectifier diodes D1 and D2 and the output capacitors CO1 and CO2, and an output voltage VO1 and an output voltage VO2 are respectively generated on the output capacitors CO1 and CO2. In addition, the feedback circuit 114 may generate a feedback signal VC1 and a feedback signal VC2 in response to the output voltages VO1 and VO2. Similarly, according to the common-mode voltage VCM, the feedback signals VC1 and VC2, the ramp voltage VRAMP and the sensing voltage VFF, the control circuit 110 may generate the control signals HG and LG.

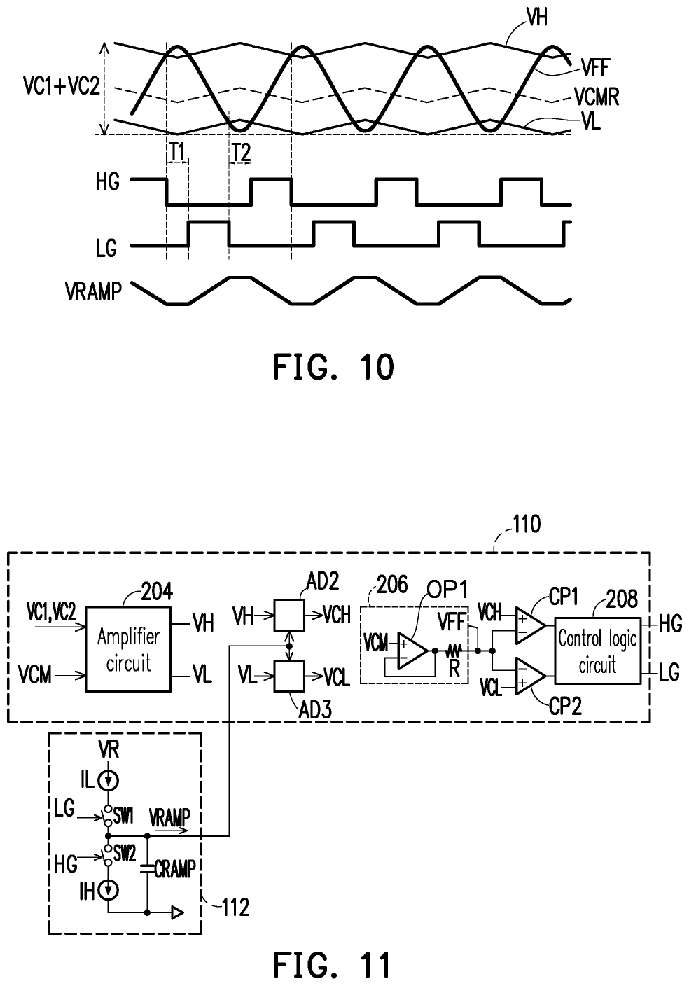

As shown in FIG. 9, a difference between the embodiment of FIG. 9 and the embodiment of FIG. 2 is that, the amplifier circuit 204 receives the two feedback signals VC1 and VC2, such that the voltage difference between the peak of the threshold voltage VH and the valley of the threshold voltage VL becomes a voltage sum of the feedback signals VC1 and VC2 (as shown in FIG. 10). Since the embodiment of FIGS. 8 to 10 only differs from the embodiment of FIGS. 1 to 5 in the numbers of output voltages and feedback signals, one of original skill in the art may derive the implementation of FIGS. 8 to 10 from the aforesaid embodiments. Therefore, details thereof will not be repeated.

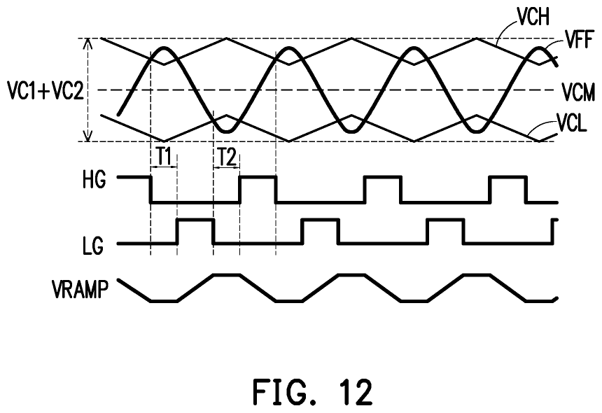

Similarly, the embodiment of FIGS. 11 and 12 only differs from the embodiment of FIGS. 6 and 7 in that the amplifier circuit 204 receives the feedback signals VC1 and VC2 generated in response to the output voltages VO1 and VO2, and outputs the threshold voltages VH and VL according to the feedback signals VC1 and VC2 and the common-mode signal VCM. In addition, compared with the embodiment of FIG. 7, in the present embodiment, the voltage difference between the peak of the adjusted threshold voltage VCH and the valley of the adjusted threshold voltage VCL is equal to the voltage sum of the feedback signals VC1 and VC2. Since the embodiment of FIGS. 11 and 12 only differs from the embodiment of FIGS. 6 and 7 in the numbers of output voltages and feedback signals, one of original skill in the art may derive the implementation of FIGS. 11 to 12 from the aforesaid embodiments. Therefore, details thereof will not be repeated.

In summary, in the embodiments of the disclosure, the control circuit may provide two control signals according to the sensing voltage generated by sensing the voltage on the resonant capacitor of the primary side, so as to control the conduction state of the half-bridge switch circuit. In this way, by controlling on/off switching of the half-bridge switch circuit according to the sensing voltage from the primary side, response speed and bandwidth of the LLC converter circuit can be effectively improved.

What is claimed is:

1. An LLC converter circuit comprising:
a half-bridge switch circuit, having a first input terminal receiving an input voltage and a second input terminal, controlled by a first control signal and a second control signal to alternately connect an output terminal of the half-bridge switch circuit to the first input terminal and the second input terminal;
a transformer, having a primary coil and a secondary coil, a first terminal of the primary coil being coupled to the output terminal of the half-bridge switch circuit, the secondary coil being coupled to an output terminal of the LLC converter circuit;
a resonant network, coupled to the output terminal of the half-bridge switch circuit and comprising:
a resonant capacitor, coupled between a second terminal of the primary coil and ground;
a sensing circuit, coupled to the second terminal of the primary coil, and sensing a voltage on the resonant capacitor to generate a sensing voltage;
a control circuit, coupled to the sensing circuit and the half-bridge switch circuit, and generating the first control signal and the second control signal, the control circuit comprising:
an amplifier circuit, generating a first threshold voltage and a second threshold voltage respectively at a first output terminal and a second output terminal of the amplifier circuit according to a first common-mode voltage and a feedback signal generated in response to an output voltage of the LLC converter circuit, the control circuit generating the first control signal and the second control signal according to the sensing voltage, the first threshold voltage and the second threshold voltage; and
a ramp voltage generation circuit, coupled to the control circuit, and generating a ramp voltage according to the first control signal and the second control signal, so as to adjust the first common-mode voltage or adjust the first threshold voltage and the second threshold voltage.

2. The LLC converter circuit according to claim 1, wherein the control circuit further comprises:
a first comparator, having a positive input terminal and a negative input terminal respectively coupled to the first threshold voltage and the sensing voltage;
a second comparator, having a positive input terminal and a negative input terminal respectively coupled to the second threshold voltage and the sensing voltage; and
a logic control circuit, coupled to an output terminal of the first comparator and an output terminal of the second comparator, and generating the first control signal and the second control signal according to a comparison result of the first comparator and a comparison result of the second comparator.

3. The LLC converter circuit according to claim 2, wherein the control circuit further comprises:
a first adder circuit, coupled to the ramp voltage generation circuit, the first output terminal of the amplifier circuit, and the positive input terminal of the first comparator, and adding the ramp voltage and the first threshold voltage, so as to adjust the first threshold voltage to generate a third threshold voltage to the positive input terminal of the first comparator; and
a second adder circuit, coupled to the ramp voltage generation circuit, the second output terminal of the amplifier circuit, and the positive input terminal of the second comparator, and adding the ramp voltage and the second threshold voltage, so as to adjust the second threshold voltage to generate a fourth threshold voltage to the positive input terminal of the second comparator.

4. The LLC converter circuit according to claim 2, wherein the control circuit further comprises:
an adder circuit, coupled to the ramp voltage generation circuit, the first common-mode voltage and an input terminal of the amplifier circuit, and adding the ramp voltage and the first common-mode voltage, so as to adjust the first common-mode voltage to generate a second common-mode voltage to the amplifier circuit, the amplifier circuit generating the first threshold voltage and the second threshold voltage respectively at the first output terminal and the second output terminal of the amplifier circuit according to the second common-mode voltage and the feedback signal.

5. The LLC converter circuit according to claim 2, further comprising:
a unity gain amplifier circuit, having a positive input terminal coupled to the first common-mode voltage and having a negative input terminal and an output terminal coupled to each other, the output terminal of the unity gain amplifier circuit being coupled to the negative input terminal of the first comparator and the negative input terminal of the second comparator.

6. The LLC converter circuit according to claim 1, further comprising:
a feedback circuit, coupled to the output terminal of the LLC converter circuit and an input terminal of the amplifier circuit, and generating the feedback signal according to the output voltage of the LLC converter circuit.

7. The LLC converter circuit according to claim 1, wherein the LLC converter circuit comprises a first output terminal and a second output terminal, and the feedback signal comprises a first feedback signal and a second feedback signal generated in response to a first output voltage on the first output terminal and a second output voltage on the second output terminal.

8. The LLC converter circuit according to claim 1, wherein the ramp voltage generation circuit comprises:
a first current source, coupled to a reference voltage;
a first switch, coupled between the first current source and an output terminal of the ramp voltage generation circuit;
a second switch, having one terminal coupled to the output terminal of the ramp voltage generation circuit;
a second current source, coupled between the other terminal of the second switch and the ground; and
a capacitor, coupled between the output terminal of the ramp voltage generation circuit and the ground, the first switch and the second switch being controlled by the first control signal and the second control signal to change conduction state, thereby generating the ramp voltage at the output terminal of the ramp voltage generation circuit.

9. The LLC converter circuit according to claim 1, wherein the sensing circuit is a voltage divider circuit or a high-pass filter circuit.

10. The LLC converter circuit according to claim 1, wherein the sensing circuit comprises:
a capacitor; and
a resistor, coupled to the capacitor between the second terminal of the primary coil and the ground, the sensing voltage being generated on a common contact of the capacitor and the resistor.

11. The LLC converter circuit according to claim 1, wherein the sensing circuit comprises:
a first capacitor; and
a second capacitor, coupled to the first capacitor between the second terminal of the primary coil and the ground, the sensing voltage being generated on a common contact of the first capacitor and the second capacitor.
